(19) United States
(12) Patent Application Publication
(10) Pub. No.: US 2012/0311494 A1
(43) Pub. Date: Dec. 6, 2012

(54) Persistently Displaying Transient Content

(75) Inventors: Bunny Laden, Los Gatos, CA (US); David Michael Arrigoni, II, San Jose, CA (US); Karin Patrice O'Connor, Morgan Hill, CA (US)

(73) Assignee: APPLE INC., Cupertino, CA (US)

(21) Appl. No.: 13/153,177

(22) Filed: Jun. 3, 2011

(51) Int. Cl. G06F 3/048

(52) U.S. Cl. 715/810

(57) ABSTRACT

In some implementations, a transient user interface is transformed into a persistent user interface in response to receiving a selection of a graphical object displayed on the transient user interface. In some implementations, in response to receiving the selection, content displayed on the transient user interface is displayed on the persistent user interface.

### TECHNICAL FIELD

The disclosure generally relates to displaying content on graphical user interfaces.

### BACKGROUND

Software graphical user interfaces are designed to display various types of content in a variety of ways. Some user interface elements (e.g., popup menus, pull down menus, etc.) are displayed for a short period of time (e.g., are transient) and allow users the opportunity to only provide a single input or make a single selection before the user interface element is removed from the display. Some user interface elements are displayed for longer periods of time (e.g., are persistent). For example, persistent user interface elements can allow users the opportunity to provide multiple inputs or make multiple selections and can close when the user provides explicit input to close or hide the user interface element. One type of user interface element may be more appropriate for displaying content than another type of user interface element depending on the how the user is interacting with the software associated with the user interface element.

### SUMMARY

In some implementations, a transient user interface is transformed into a persistent user interface in response to input, such as receiving a selection of a graphical object displayed on the transient user interface. In some implementations, in response to receiving the selection, content displayed on the transient user interface is displayed on the persistent user interface.

Particular implementations provide one or more of the following advantages: a convenient mechanism to persistently display transient content is provided; and frequently accessed or referenced transient content is more conveniently accessible to users.

Details of one or more implementations are set forth in the accompanying drawings and the description below. Other features, aspects, and potential advantages will be apparent from the description and drawings, and from the claims.

### DESCRIPTION OF DRAWINGS

FIG. 1 illustrates an example user interface for displaying content.

FIG. 2 illustrates an example transient user interface for displaying meta-content associated with the content.

FIG. 3 illustrates an example persistent user interface displaying meta-content from the transient user interface.

FIG. 4 illustrates an example of an animation for transforming a transient user interface into a persistent user interface.

FIG. 5 is flow diagram of an example process for persistently displaying transient meta-content.

FIG. 6 is a block diagram of an exemplary system architecture implementing the features and processes of FIGS. 1-5.

Like reference symbols in the various drawings indicate like elements.

### DETAILED DESCRIPTION

### User Interfaces

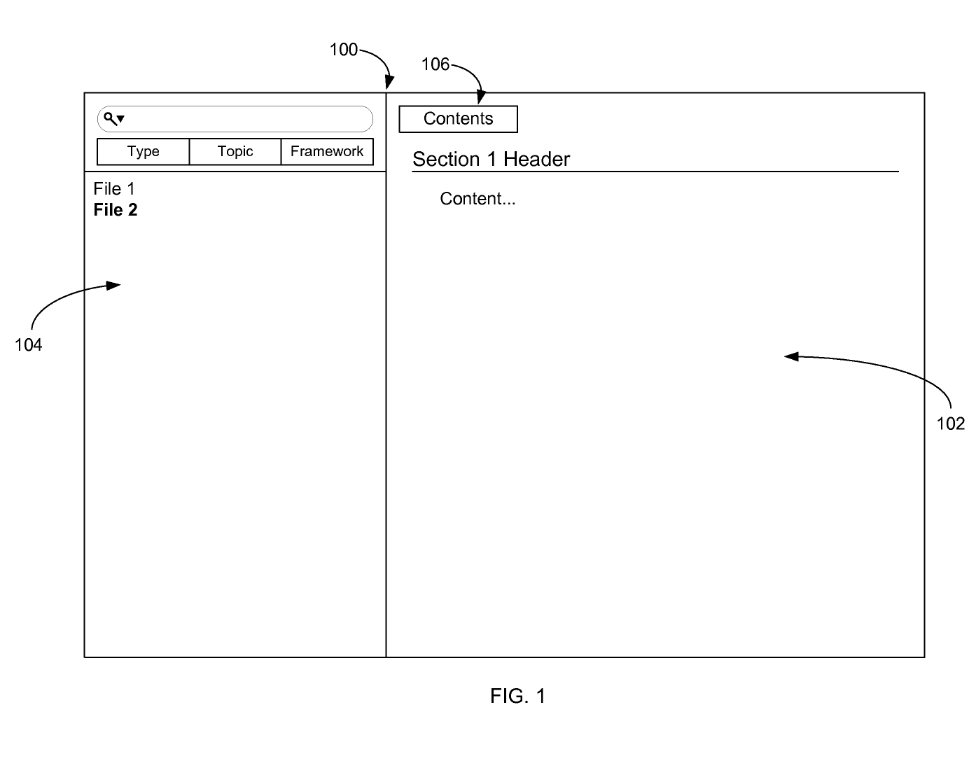

FIG. 1 illustrates an example application user interface 100 for displaying content. For example, application user interface 100 can be a user interface of an application hosted on a computing device. Application user interface 100 can be an interface of a web browser, an electronic document reader, a media player or any other software application that presents content to a user for viewing.

Application user interface 100 can include a content display area 102. For example, content display area 102 can display web content, document content, media content or any other content type. For example, if application user interface 100 is an interface for viewing electronic documents, content display area 102 can be configured to display the content of the electronic documents. If application user interface 100 is an interface of a media application, the content display area 102 can be configured to display media (e.g., movie, video clip, photographs, etc.).

Application user interface 100 can include an information area 104 for displaying information related to content displayed in content display area 102. For example, information area 104 can display navigation information, such as a directory of files (e.g., File 1, File 2, etc.) accessible to application user interface 100 (e.g., the application associated with application user interface 100). The file names displayed in information area 104 can correspond to files that are stored locally on the computing device hosting the application associated with application user interface 100. The files displayed in information area 104 can correspond to files stored on a network server and accessible over a network (e.g., the Internet). The files can be electronic documents (e.g., text documents), web pages, media files (e.g., music, videos, etc.) or any other type of file. In some implementations, information area 104 is not displayed on application user interface 100. For example, information area 104 can be hidden so that content display area 102 is substantially equal to the area of application user interface 100.

Application user interface 100 can include graphical object 106. For example, a user can select graphical object 106 to display meta-content related to the content displayed in content display area 102. Meta-content can be a table of contents for a document displayed (or partially displayed) in content display area 102, for example. Meta-content can be a list of chapters for a video or movie displayed in content display area 102. Meta-content can be a listing of songs in a music album, for example. In some implementations, selection of graphical object 106 can cause a transient user interface to be displayed that presents meta-content associated with content displayed in content display area 102.

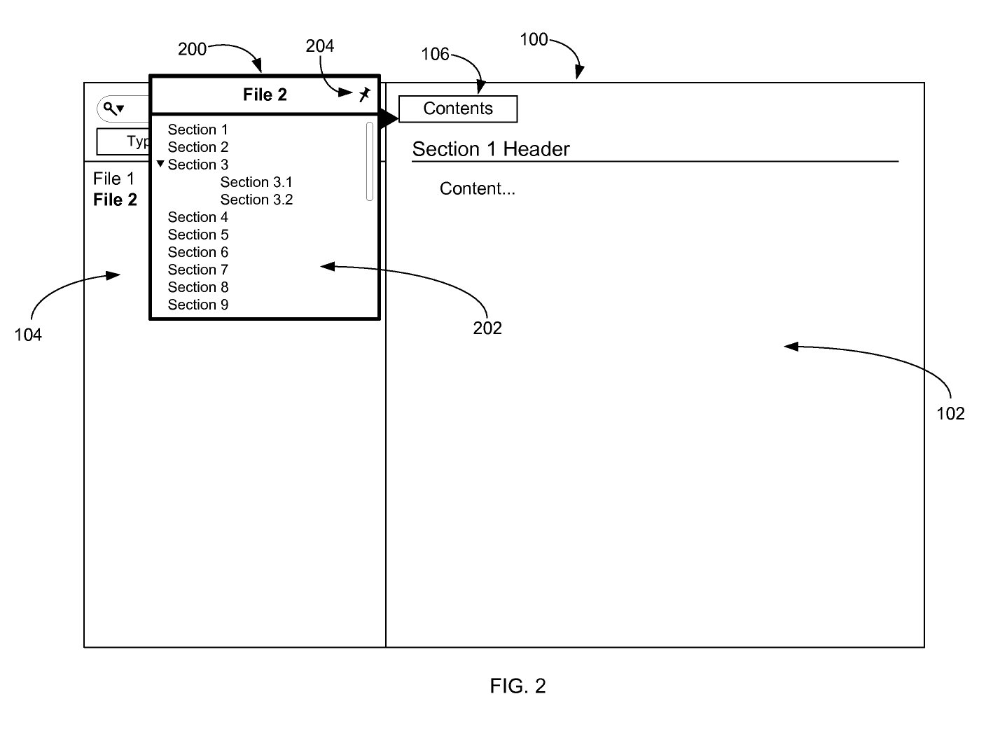

FIG. 2 illustrates an example transient user interface 200 for displaying meta-content associated with the content. In some implementations, in response to a selection of graphical object 106, transient user interface 200 can be displayed. For example, transient user interface 200 can be a temporary popover window, a popup window, pull down menu, or any other appropriate user interface for temporarily displaying information. In some implementations, transient user interface 200 is visible until an object displayed on transient user interface 200 is selected. For example, transient user interface 200 may disappear, be hidden or removed from view once a user has selected an object displayed on transient application user interface 100.

Transient user interface 200 can be configured to display meta-content associated with content displayed in content display area 102. For example, if File 2 (or a portion of File 2) is displayed in content display area 102, then meta-content (e.g., a table of contents) for File 2 can be displayed on transient user interface 200. In the example shown in FIG. 2, the table of contents for File 2 displayed in display area 202 of transient user interface 200 includes file Sections 1-9. A user can select one of the sections to cause the selected section of File 2 to be displayed in content display area 102. When a user selects one of the sections (e.g., Sections 1-9), transient user interface 200 can be removed from display.

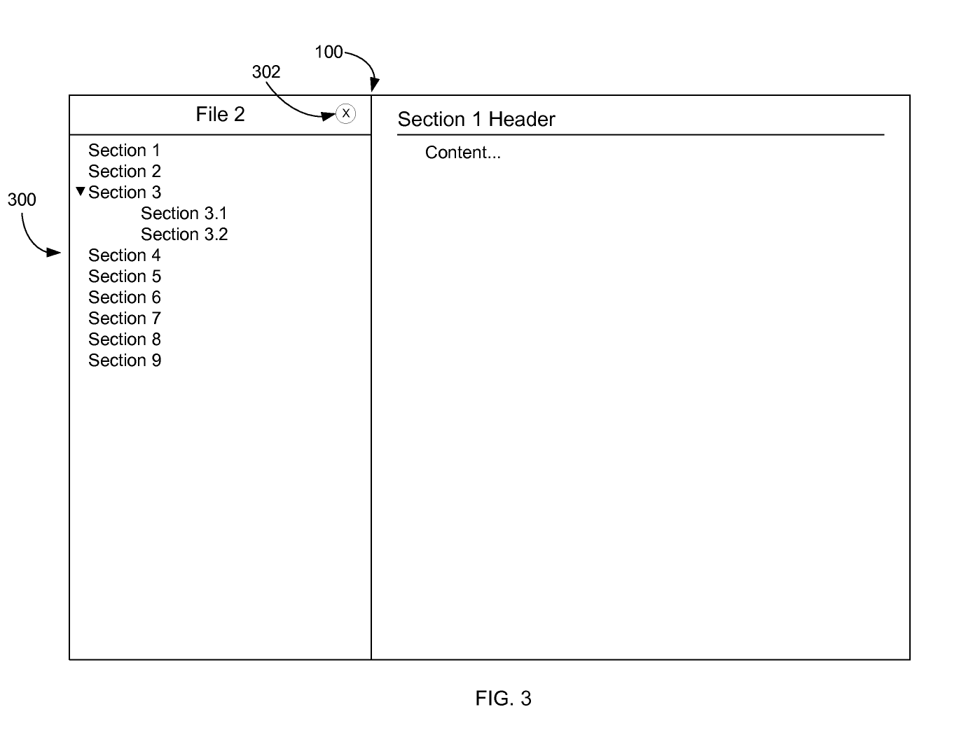

Transient user interface 200 can include a graphical object 204. In some implementations, graphical object 204 can be selected to cause transient user interface 200 to transform into a persistent user interface (e.g., interface 300 of FIG. 3, below) that can persistently display the meta-content displayed on transient user interface 200, as described further below with reference to FIGS. 3-5.

FIG. 3 illustrates an example persistent user interface 300 displaying meta-content from transient user interface 200. In some implementations, persistent user interface 300 can be displayed in response to a selection of graphical object 204 of FIG. 2. In some implementations, when persistent user interface is displayed, transient user interface is removed from view or hidden. In some implementations, persistent user interface 300 can be configured to display the meta-content previously displayed by transient user interface 200. For example, if transient user interface 200 displayed a table of contents for File 2 (e.g., Sections 1-9), then when persistent user interface 300 is displayed persistent user interface 300 can display the table of contents for File 2, as illustrated by FIG. 3.

In contrast to transient user interface 200, persistent user interface 300 is removed from display by an explicit close. For example, persistent user interface 300 will remain displayed until a user explicitly closes persistent user interface 300. A user can explicitly close persistent user interface 300 by selecting close object 302, for example. A user can explicitly close persistent user interface 300 by closing application user interface 100 or by closing or terminating the application associated with application user interface 100.

In some implementations, persistent user interface 300 can replace information area 104. For example, when graphical object 204 is selected, persistent user interface 300 can be displayed over or in place of information area 104. If information area 104 is not displayed at the time graphical object 204 is selected (e.g., the area content display area 102 is substantially the same size as application user interface 100), then the size of content display area 102 can be adjusted to make a space on application user interface 100 to display persistent user interface 300.

In some implementations, the size of persistent user interface 300 can be dynamically adjusted based on the characteristics of the meta-content displayed on persistent user interface 300. For example, if table of contents entries displayed on persistent user interface 300 have short names, then the width of persistent user interface 300 can be narrowed to the length of the short names. If table of contents entries displayed on persistent user interface 300 have long names, then the width of persistent user interface 300 can be increased, up to a configured limit, to accommodate the long names. In some implementations, the height of persistent user interface 300 can be substantially the height of application user interface 100. In some implementations, if information area 104 is displayed, the dimensions (e.g., height and width) can be substantially the same as the dimensions of information 104. In some implementations, persistent user interface 300 can include horizontal and vertical scroll elements (not shown) to allow a user to view the meta-content displayed on persistent user interface 300.

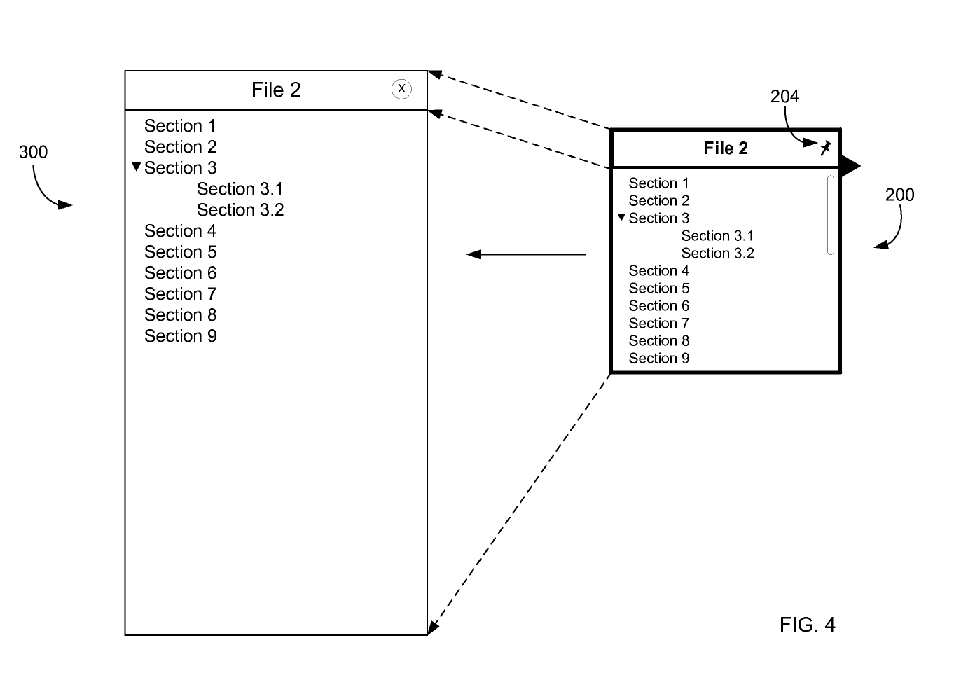

FIG. 4 illustrates an example of an animation for transforming a transient user interface 200 into persistent user interface 300. In some implementations, when a user selects graphical object 204 on transient user interface 200, an animation can be displayed that transforms transient user interface 200 into persistent user interface 300. For example, the animation can cause transient user interface to appear to transform (morph, transmute) into persistent user interface 300. The height and/or width of transient user interface 200 can be adjusted (e.g., expanded, reduced) to the height and/or width of persistent user interface 300. Thus, transient user interface 200 can appear to grow or expand to become persistent user interface 300.

### Example Process

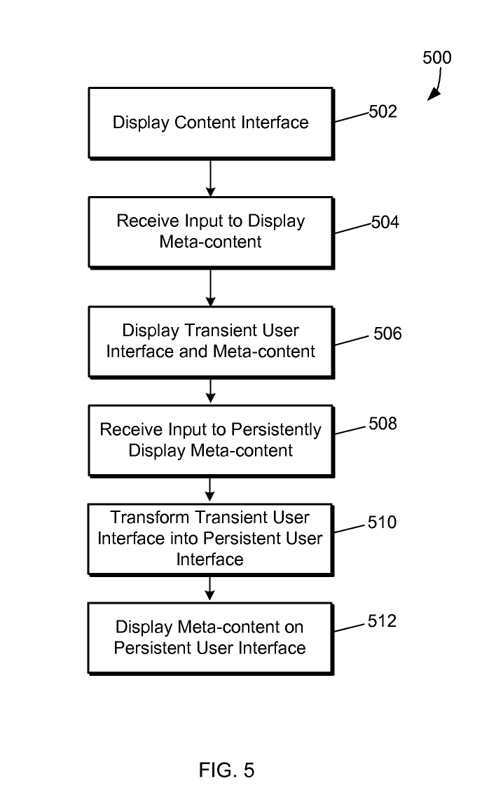

FIG. 5 is flow diagram of an example process 500 for persistently displaying transient meta-content. In some implementations, process 500 can allow a user to provide input that causes a transient user interface to transform into a persistent user interface thereby causing meta-content that would be temporarily displayed on the transient user interface to be persistently displayed or “pinned” on the persistent user interface. Thus, meta-content that a user needs to reference frequently but that would normally be displayed on the transient user interface can be made available to the user in a more convenient and permanent manner.

At step 502, a content interface can be displayed. For example, the content interface can be an interface of a web browser, a document editing/viewing application, a media application (e.g., video, pictures, music, etc.) or any other type of application for presenting content to a user.

At step 504, input to display meta-content can be received. For example, meta-content can be a table of contents associated with the content displayed on the content interface. The meta-content can be informational content related to the content displayed on the content interface. For example, if the content interface is displaying music by a particular artist, the meta-content can be other songs, albums, or information related to the particular artist. In some implementations, the input is received in response to a user selecting a graphical object (e.g., button) displayed on the content interface. In some implementations, the input can be received as non-graphical user interface specific input. For example, the input can be received as keyboard input (e.g., a key stroke or combination of key strokes) or input from a cursor device (e.g., a button or other input from a mouse, trackball, etc.).

At step 506, a transient user interface for presenting meta-content can be displayed. For example, in response to receiving the input at step 504, a transient user interface (e.g., transient user interface 200) can be displayed over the content interface (e.g., interface 100). For example, a transient interface can be an interface that is displayed to present selectable objects to a user and allow the user to make a single object selection (e.g., excluding manipulation, scrolling of the transient user interface). Once the user has selected an object, the transient user interface can be removed from the display.

In some implementations, the transient user interface can display meta-content. For example, a user can select an item of meta-content displayed on transient user interface to cause content associated with the item of meta-content to be displayed in the content interface. For example, if an electronic book (e-book) is displayed in the content interface, the transient user interface can display a table of contents (meta-content) for the e-book. A user can select a chapter or section from the table of contents to cause the selected chapter or section to be displayed on the content interface. Once a selection is made, the transient user interface can be hidden or removed from view.

At step 508, input to persistently display meta-content can be received. In some implementations, a user can select a graphical object on the transient user interface to cause the content displayed on the transient user interface to be persistently displayed. For example, a user may wish to reference the table of contents of a technical manual frequently while reading the technical manual. It can be frustrating for the user to have to repeatedly invoke the transient user interface to reference the table of contents. Thus, the user may wish to persistently (e.g., permanently) display the table of contents while the user is interacting with the technical document. In some implementations, other types of input (e.g., keyboard key strokes, cursor device input, etc.) can be received to cause meta-content displayed on a transient user interface to be persistently displayed.

At step 510, the transient user interface can be transformed into a persistent user interface. In some implementations, in response to the input received at step 508, meta-content displayed on a transient user interface can be displayed on a persistent user interface. For example, the transient user interface can be transformed into a persistent user interface, as described above with reference to FIG. 4. The meta-content displayed on the transient user interface can be displayed on the persistent user interface so that the user can reference the meta-content on an on-going basis. For example, in contrast to the transient user interface, the persistent user interface will not disappear after a user selects an item of meta-content displayed on the persistent user interface. In some implementations, the persistent user interface is removed from the display only after the user explicitly indicates that the persistent user interface should be closed (e.g., an explicit close command or input is received). For example, to close the persistent user interface the user can select a close graphical object displayed on the persistent user interface. Other examples of explicit close commands include closing the software application associated with the persistent user interface and/or closing the content interface.

At step 512, meta-content previously displayed on the transient user interface can be displayed on the persistent user interface. For example, the meta-content displayed on the transient user interface can be displayed on the persistent user interface after the transformation performed at step 510.

### Example System Architecture

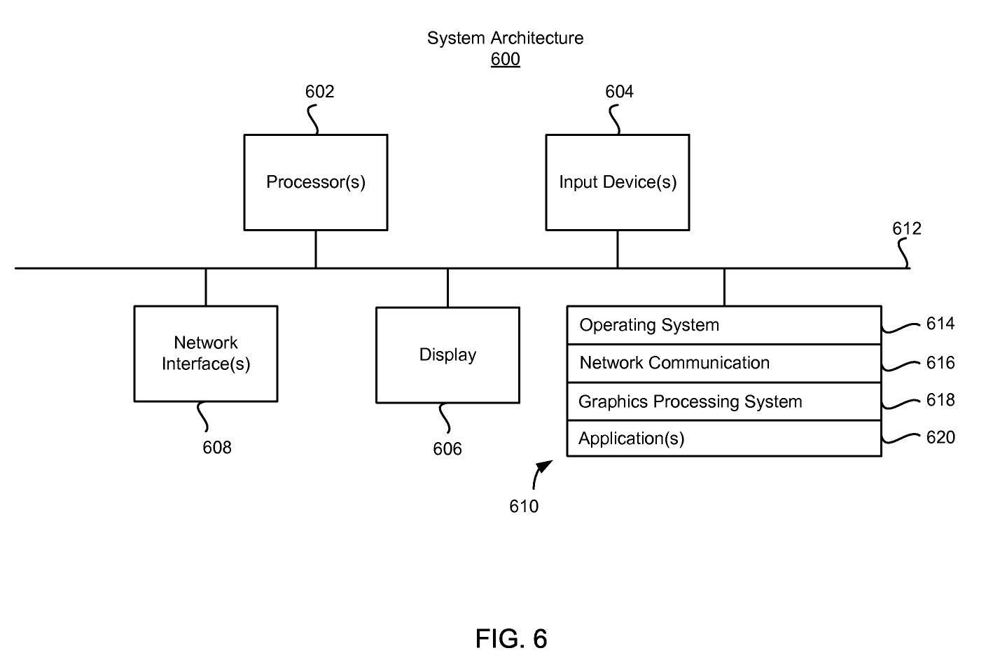

FIG. 6 is a block diagram of an exemplary system architecture implementing the features and processes of FIGS. 1-5. The architecture 600 can be implemented on any electronic device that runs software applications derived from compiled instructions, including without limitation personal computers, servers, smart phones, media players, electronic tablets, game consoles, email devices, etc. In some implementations, the architecture 600 can include one or more processors 602, one or more input devices 604, one or more display devices 606, one or more network interfaces 608 and one or more computer-readable mediums 610. Each of these components can be coupled by bus 612.

Display device 606 can be any known display technology, including but not limited to display devices using Liquid Crystal Display (LCD) or Light Emitting Diode (LED) technology. Processor(s) 602 can use any known processor technology, including but are not limited to graphics processors and multi-core processors. Input device 604 can be any known input device technology, including but not limited to a keyboard (including a virtual keyboard), mouse, track ball, and touch-sensitive pad or display. Bus 612 can be any known internal or external bus technology, including but not limited to ISA, EISA, PCI, PCI Express, NuBus, USB, Serial ATA or FireWire. Computer-readable medium 610 can be any medium that participates in providing instructions to processor(s) 602 for execution, including without limitation, non-volatile storage media (e.g., optical disks, magnetic disks, flash drives, etc.) or volatile media (e.g., SDRAM, ROM, etc.).

Computer-readable medium 610 can include various instructions 614 for implementing an operating system (e.g., Mac OS®, Windows®, Linux). The operating system can be multi-user, multiprocessing, multitasking, multithreading, real-time and the like. The operating system performs basic tasks, including but not limited to: recognizing input from input device 604; sending output to display device 606; keeping track of files and directories on computer-readable medium 610; controlling peripheral devices (e.g., disk drives, printers, etc.) which can be controlled directly or through an I/O controller; and managing traffic on bus 612. Network communications instructions 616 can establish and maintain network connections (e.g., software for implementing communication protocols, such as TCP/IP, HTTP, Ethernet, etc.). A graphics processing system 618 can include instructions that provide graphics and image processing capabilities.

Application(s) 620 can be an application that uses or implements the processes described with reference to FIGS. 1-5. The processes described with reference to FIGS. 1-5 can be implemented in operating system 614.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an API. An API can define on or more parameters that are passed between a calling application and other software code (e.g., an operating system, library routine, function) that provides a service, that provides data, or that performs an operation or a computation.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API.

In some implementations, an API call can report to an application the capabilities of a device running the application, such as input capability, output capability, processing capability, power capability, communications capability, etc.

A number of implementations have been described. Nevertheless, it will be understood that various modifications may be made. For example, other steps may be provided, or steps may be eliminated, from the described flows, and other components may be added to, or removed from, the described systems. Accordingly, other implementations are within the scope of the following claims.

What is claimed is:

1. A method comprising:
causing a transient user interface to be displayed on a display of a computing device, the transient user interface configured to temporarily present content;
receiving a selection of a graphical object displayed on the transient user interface;
responsive to the selection, causing an animation to be displayed that appears to transform the transient user interface into a persistent user interface, the persistent user interface configured to permanently present the content,
wherein the method is performed by one or more processors.

2. The method of claim 1, wherein the content is meta-content for media displayed on an application user interface associated with the transient user interface.

3. The method of claim 1, wherein the content is meta-content for a document displayed on an application user interface associated with the transient user interface.

4. The method of claim 1, wherein the content is a table of contents.

5. The method of claim 1, wherein the transient user interface has a first dimensions and the persistent user interface has a second dimensions, wherein the first dimensions are different than the second dimensions.

6. The method of claim 1, wherein the transient user interface has a first shape and the persistent user interface has a second shape, wherein the first shape is different than the second shape.

7. The method of claim 1, wherein the persistent user interface remains visible after a selection of an item of the content is received.

8. The method of claim 1, wherein the transient user interface is hidden after a selection of an item of the content is received.

9. A non-transitory computer-readable medium including one or more sequences of instructions which, when executed by one or more processors, causes:
displaying a transient user interface on a display of a computing device, the transient user interface configured to temporarily present content;
receiving a selection of a graphical object displayed on the transient user interface;
responsive to the selection, causing an animation to be displayed that appears to transform the transient user interface into a persistent user interface, the persistent user interface configured to permanently present the content,
wherein the method is performed by one or more processors.

10. The non-transitory computer-readable medium of claim 9, wherein the content is meta-content for media displayed on an application user interface associated with the transient user interface.

11. The non-transitory computer-readable medium of claim 9, wherein the content is meta-content for a document displayed on an application user interface associated with the transient user interface.

12. The non-transitory computer-readable medium of claim 9, wherein the content is a table of contents.

13. The non-transitory computer-readable medium of claim 9, wherein the transient user interface has a first dimensions and the persistent user interface has a second dimensions, wherein the first dimensions are different than the second dimensions.

14. The non-transitory computer-readable medium of claim 9, wherein the transient user interface has a first shape and the persistent user interface has a second shape, wherein the first shape is different than the second shape.

15. The non-transitory computer-readable medium of claim 9, wherein the persistent user interface remains visible after a selection of an item of the content is received.

16. The non-transitory computer-readable medium of claim 9, wherein the transient user interface is hidden after a selection of an item of the content is received.

17. A system comprising:
one or more processors; and
a computer-readable medium including one or more sequences of instructions which, when executed by one or more processors, causes:
displaying a transient user interface on a display of a computing device, the transient user interface configured to temporarily present content;
receiving a selection of a graphical object displayed on the transient user interface;
responsive to the selection, causing an animation to be displayed that appears to transform the transient user interface into a persistent user interface, the persistent user interface configured to permanently present the content,
wherein the method is performed by one or more processors.

18. The system of claim 17, wherein the content is meta-content for media displayed on an application user interface associated with the transient user interface.

19. The system of claim 17, wherein the content is meta-content for a document displayed on an application user interface associated with the transient user interface.

20. The system of claim 17, wherein the content is a table of contents.
